(19) United States
(12) Patent Application Publication
(10) Pub. No.: US 2026/0220286 A1
(43) Pub. Date: Jul. 30, 2026

(54) SYSTEM AND METHOD FOR AUTOMATIC REAL-TIME IDENTIFICATION OF AND COMPLIANCE WITH WORLDWIDE DATA PROTECTION RULES FOR ONLINE INTERACTIONS

(71) Applicant: Nice Ltd., Ra'anana (IL)

(72) Inventors: Seemit Vijay SHAH, Pune (IN); Salil DHAWAN, Pune (IN); Darshan AMBHAIKAR, Pune (IN)

(73) Assignee: Nice Ltd., Ra'anana (IL)

(21) Appl. No.: 19/037,588

(22) Filed: Jan. 27, 2025

(51) Int. Cl. G06F 21/62

(52) U.S. Cl. CPC G06F 21/6218

(57) ABSTRACT

A system and method for automatic real-time identification of and compliance with worldwide data protection rules for online interactions is provided. An online interaction can be received, an applicable data protection rule based on a location of a sender of the online interaction can be determined, compliance rules can be created in real-time using machine learning, where the compliance rules can indicate access, security and/or retention policy for the interaction.

### TECHNICAL FIELD OF THE INVENTION

The present invention relates generally to ensuring systems are complying with data protection rules. In particular, to improving automatically identifying and complying with the worldwide data protection rules for online interactions.

### BACKGROUND OF THE INVENTION

Currently, it can be a major compliance challenge for computing systems (e.g., computers of a global contact center) that are operating in a worldwide capacity, receiving and transmitting data to anywhere in the world, to determine which specific data protection law applies to a given interaction (e.g., data associated with the interaction). With a vast number of regulations across different regions, such as the General Data Protection Regulation (GDPR) in the EU, the Australian Privacy Principles (APP), and data localization laws in China, computing systems must ensure that each interaction complies with the relevant laws of the region in which the message initiator is located. The complexity of manually identifying which law governs each interaction can lead to errors, non-compliance, inability to handle data compliance in real-time and potential legal penalties.

Many data protection regulations require that data be stored within the geographic boundaries of a particular region to ensure data sovereignty. For example, under GDPR, data concerning EU citizens must remain within the EU unless certain conditions are met. It can be a challenge to determine for online interactions the exact region where interaction data must be stored to meet the legal requirements because, for example, user location data can be ambiguous (e.g., due to VPNs or incomplete metadata), interactions often span multiple jurisdictions, and regulations like GDPR involve complex, overlapping requirements. Legacy systems and real-time processing constraints can further complicate compliance automation.

Data retention can be another complex issue faced by computing systems that accommodate global interactions. Depending on the type of data (e.g., PCI, PII, health data), different laws can dictate how long the data must or can be stored. For example, some data must be retained for several years, while other sensitive data must be deleted after a short period to protect privacy according to the particular rules. It can be difficult to automatically determine for online interactions to determine the appropriate retention periods for each type of data because, for example, navigating these overlapping and sometimes conflicting regulations programmatically complicates the establishment of uniform data retention policies. The complexity can also arise from the need to navigate a patchwork of international laws, accurately classify diverse data types, adapt to evolving regulations, and/or implement technically robust solutions. Therefore, it can be desirable to ensure compliance with various laws while protecting customer privacy and/or minimizing storage costs.

Data protection laws often require strict access controls, ensuring that only authorized personnel with a legitimate need can view or manipulate certain data. Managing these access controls with a computing system in a dynamic, multi-regional environment, often with tens of thousands of employees presents significant challenges, especially when different regions may impose specific access restrictions. Difficulty with current systems can include inconsistent policy enforcement that can arises as varied regional regulations make it hard to apply uniform access controls, potentially resulting in compliance gaps. Other difficulties can include complex role management as, for example, accurately defining and maintaining roles that reflect diverse responsibilities across a global workforce is both time-consuming and prone to errors. Security risks can be heightened when access control systems are inadequate or improperly managed, leading to, for example, potential unauthorized access and data breaches.

Data security is paramount, particularly when dealing with sensitive customer information. In a multi-region computing environment, ensuring that data is encrypted and protected across multiple locations can be a significant challenge. For example, some difficulties with current systems include managing encryption keys consistently across different regions, complying with varying regional data protection regulations, maintaining system performance despite the overhead of encryption processes, and/or integrating modern encryption technologies with legacy systems that may not support them. Many data protection laws require encryption both at rest and in transit, adding complexity to managing secure data storage and transfer across borders. Furthermore, encryption keys and methods may need to comply with region-specific regulations, and failure to do so can lead to severe legal consequences and data breaches.

Data protection laws and regulations across multiple regions can periodically change. Currently, many global computing systems have difficulty static and manual storage management systems. For example, a multinational company operating in both the European Union and Canada can be required to comply with continual updates to GDPR and PIPEDA regulations. With static and/or manual storage management systems, companies can struggle to quickly adjust data retention policies to meet the updated requirements, resulting in potential compliance breaches. Manually updating storage configurations across multiple regions can increase the risk of errors and delays in adhering to the latest legal standards. This can lead to compliance risks as laws and regulations evolve. Without a dynamic solution, currently computing systems can fail regular compliance audits, have difficulty maintaining up-to-date reporting, and/or ensuring that their data practices align with relevant legal requirements.

Existing static solutions can make required auditing and reporting process time-consuming and prone to errors due to, for example, reliance on manual data entry, lack of real-time integration with data sources, and difficulty in maintaining consistent compliance across multiple jurisdictions. For systems that manually update to comply with the laws, auditing and reporting can cause significant delays and/or increase the likelihood of human errors. These delays can prevent timely identification of compliance issues, while inaccuracies in reports may lead to incomplete audit trails. Consequently, organizations can face a heightened risk of non-compliance, increasing the risk of fines and penalties for non-compliance. This invention addresses the challenge of creating a streamlined, auditable, and reportable process that can adapt to region-specific regulations.

Therefore, it can be desirable to create a streamlined, auditable, and reportable process that can adapt to region-specific regulations.

### SUMMARY OF THE INVENTION

Advantages of the invention can include a streamlined, easily auditable and/or reportable process for adapting to region-specific laws and regulations. Advantages of the invention can also include an ability to ensure multi-region real-time computing interactions comply with the correct regional law, including storage in the correct location and access given to the correct entities in real-time.

Advantages of the invention can also include ensuring data sovereignty and compliance in a global multi-region contact center. Advantages of the invention can also include improved data storage, retention, transfer, and/or security in a global multi-region contact center. Advantages of the invention can also include ensure seamless compliance with various data protection laws across different regions, dynamically adapting to regulatory changes, and/or providing comprehensive tools for retrospective compliance management.

Advantages of the invention can also include reducing the operational burden on contact centers, mitigation of legal risks, and ensures data sovereignty in a highly automated and efficient manner.

In one aspect, the invention involves a method for automatic real-time identification of and compliance with worldwide data protection rules for online interactions. The method can involve receiving, by a computer, an online interaction. The method can also involve determining, by the computer, an applicable data protection rule based on a location of a sender of the online interaction, a location of the computer receiving the online interaction, a desired location of the interaction, or any combination thereof. The method can also involve determining, by the computer, one or a plurality of data storage regions based on the applicable data protection rule, data storage cost, available regions that the computer can store data in, preferred region, or any combination thereof. The method can also involve creating in real-time, by the computer, a compliance rule that can be used to indicate access, security, retention policies or any combination thereof, wherein the compliance rule is based on the applicable data protection rule and a machine learning model. The method can also involve transmitting, by the computer, the compliance rule with its respective online interaction to a multi region cloud storage system.

In some embodiments, determining the applicable data protection rule is further based on a machine learning model, wherein the machine learning model is trained a plurality of interactions, each interaction including the sender of the online interaction, the location of the computer receiving the online interaction, a desired location of the interaction, or any combination thereof.

In some embodiments, for plurality of data storage region determining the data storage region further comprises determining, by the computer, a compliance score for each of the plurality of regions based on a machine learning model, determining, by the computer, a cost for each of the plurality of regions, determining, by the computer, a speed for each of the plurality of regions, and selecting one region of the plurality of regions to store the data in based on the compliance score, the cost, the speed or any combination thereof.

In some embodiments, the selection of one region is based on weighting the compliance score, the cost and the speed. In some embodiments, the method further involves receiving a request to delete, change, store or access data from an application, and determining based on the compliance rule whether the request can be executed.

In some embodiments, the method further involves receiving a request to determine compliance rate for a particular entity, determining the compliance rate by evaluating the transaction location storage and associated metadata, and transmitting, by the computer, the compliance rate to a display.

In some embodiments, creating in a compliance rule further comprises determining a strictness score that resolves conflict between multiple compliance rules that are determined for a single interaction.

In another aspect, the invention includes a system for automatic real-time identification of and compliance with worldwide data protection rules for online interactions. The system can include a processor configured to receive an online interaction. The system can include the processor configured to determine an applicable data protection rule based on a location of a sender of the online interaction, a location of the computer receiving the online interaction, a desired location of the interaction, or any combination thereof. The system can include the processor configured to determine one or a plurality of data storage regions based on the applicable data protection rule, data storage cost, available regions that the computer can store data in, preferred region, or any combination thereof. The system can include the processor configured to create in real-time, a compliance rule that can be used to indicate access, security, retention policies or any combination thereof, wherein the compliance rule is based on the applicable data protection rule and a machine learning model. The system can include the processor configured to transmit the compliance rule with its respective online interaction to a multi region cloud storage system.

In some embodiments, the processor can be configured to determine the applicable data protection rule is further based on a machine learning model, wherein the machine learning model is trained a plurality of interactions, each interaction including the sender of the online interaction, the location of the computer receiving the online interaction, a desired location of the interaction, or any combination thereof.

In some embodiments, for plurality of data storage region determining the data storage region further comprises determine a compliance score for each of the plurality of regions based on a machine learning model, determine a cost for each of the plurality of regions, determine a speed for each of the plurality of regions, and select one region of the plurality of regions to store the data in based on the compliance score, the cost, the speed or any combination thereof.

In some embodiments, the selection of one region is based on weighting the compliance score, the cost and the speed. In some embodiments, the processor is further configured to receive a request to delete, change, store or access data from an application, and determining based on the compliance rule whether the request can be executed.

In some embodiments, the processor is further configured to receive a request to determine compliance rate for a particular entity, determine the compliance rate by evaluating the transaction location storage and associated metadata, and transmit the compliance rate to a display.

In some embodiments, creating in a compliance rule further comprises determining a strictness score that resolves conflict between multiple compliance rules that are determined for a single interaction.

In another aspect, the invention can include non-transitory computer program product comprising instructions which, when the program is executed cause the computer to receive an online interaction. In some embodiments, the instructions which, when the program is executed determine an applicable data protection rule based on a location of a sender of the online interaction, a location of the computer receiving the online interaction, a desired location of the interaction, or any combination thereof. In some embodiments, the instructions which, when the program is executed determine one or a plurality of data storage regions based on the applicable data protection rule, data storage cost, available regions that the computer can store data in, preferred region, or any combination thereof. In some embodiments, the instructions which, when the program is executed create in real-time, a compliance rule that can be used to indicate access, security, retention policies or any combination thereof, wherein the compliance rule is based on the applicable data protection rule and a machine learning model. In some embodiments, the instructions which, when the program is executed transmit the compliance rule with its respective online interaction to a multi region cloud storage system.

In some embodiments, determining the applicable data protection rule is further based on a machine learning model, wherein the machine learning model is trained a plurality of interactions, each interaction including the sender of the online interaction, the location of the computer receiving the online interaction, a desired location of the interaction, or any combination thereof.

In some embodiments, for plurality of data storage region determining the data storage region further comprises determine a compliance score for each of the plurality of regions based on a machine learning model, determine a cost for each of the plurality of regions, determine a speed for each of the plurality of regions, and select one region of the plurality of regions to store the data in based on the compliance score, the cost, the speed or any combination thereof.

In some embodiments, the selection of one region is based on weighting the compliance score, the cost and the speed. In some embodiments, the computer program instructions further cause the computer to receive a request to delete, change, store or access data from an application, and determining based on the compliance rule whether the request can be executed.

In some embodiments, the computer program instructions further cause the computer to receive a request to determine compliance rate for a particular entity, determine the compliance rate by evaluating the transaction location storage and associated metadata, and transmit the compliance rate to a display.

In some embodiments, creating in a compliance rule further comprises determining a strictness score that resolves conflict between multiple compliance rules that are determined for a single interaction.

These, additional, and/or other aspects and/or advantages of the present invention may be set forth in the detailed description which follows; possibly inferable from the detailed description; and/or learnable by practice of the present invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of an exemplary computing device which may be used with embodiments of the present invention.

FIG. 2 is flowchart for a method automatic real-time identification of and compliance with worldwide data protection rules for online interactions, according to some embodiments of the invention.

FIG. 3 is a diagram showing the input to the generative artificial intelligence (GenAI) model, according to some embodiments of the invention.

FIG. 4 is an example of a system architecture automatic real-time identification of and compliance with worldwide data protection rules for online interactions, according to some embodiments of the invention.

FIG. 5 is a database schema for a DSCM, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein is for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. Any of the disclosed modules or units may be at least partially implemented by a computer processor.

As used herein, “machine learning”, “machine learning algorithms”, “machine learning models”, “ML”, or similar, may refer to models built by algorithms in response to/based on input sample or training data. ML models may make predictions or decisions without being explicitly programmed to do so. ML models require training/learning based on the input data, which may take various forms.

ML models may, for example, include Large Language Models (LLM) such as Generative Pre-Trained Transformer (GPT), Bidirectional Encoder Representations from Transformers (BERT), Pathways Language Model (PaLM) and the like, (artificial) neural networks (NN), decision trees, regression analysis, Bayesian networks, Gaussian networks, genetic processes, etc. Additionally or alternatively, ensemble learning methods may be used which may use multiple/modified learning algorithms, for example, to enhance performance. Ensemble methods, may, for example, include “Random forest” methods or “XGBoost” methods.

Neural networks (NN) (or connectionist systems) are computing systems inspired by biological computing systems, but operating using manufactured digital computing technology. NNs are made up of computing units typically called neurons (which are artificial neurons or nodes, as opposed to biological neurons) communicating with each other via connections, links or edges. In common NN implementations, the signal at the link between artificial neurons or nodes can be for example a real number, and the output of each neuron or node can be computed by function of the (typically weighted) sum of its inputs, such as a rectified linear unit (ReLU) function. NN links or edges typically have a weight that adjusts as learning proceeds. The weight increases or decreases the strength of the signal at a connection. Typically, NN neurons or nodes are divided or arranged into layers, where different layers can perform different kinds of transformations on their inputs and can have different patterns of connections with other layers. NN systems can learn to perform tasks by considering example input data, generally without being programmed with any task-specific rules, being presented with the correct output for the data, and self-correcting, or learning.

Various types of NNs exist. For example, a convolutional neural network (CNN) can be a deep, feed-forward network, which includes one or more convolutional layers, fully connected layers, and/or pooling layers. CNNs are particularly useful for visual applications. Other NNs can include for example transformer NNs, useful for speech or natural language applications, and long short-term memory (LSTM) networks.

Typical NNs can require that nodes of one layer depend on the output of a previous layer as their inputs. Current systems typically proceed in a synchronous manner, first typically executing all (or substantially all) of the outputs of a prior layer to feed the outputs as inputs to the next layer. Each layer can be executed on a set of cores synchronously (or substantially synchronously), which can require a large amount of computational power, on the order of 10s or even 100s of Teraflops, or a large set of cores. On modern GPUs this can be done using 4,000-5,000 cores.

It will be understood that any subsequent reference to “machine learning”, “machine learning algorithms”, “machine learning models”, “ML”, or similar, may refer to any/all of the above ML examples, as well as any other ML models and methods as may be considered appropriate.

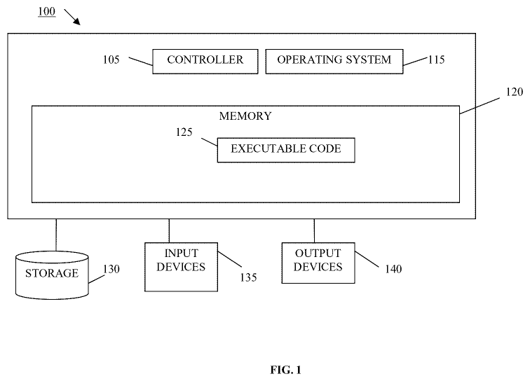

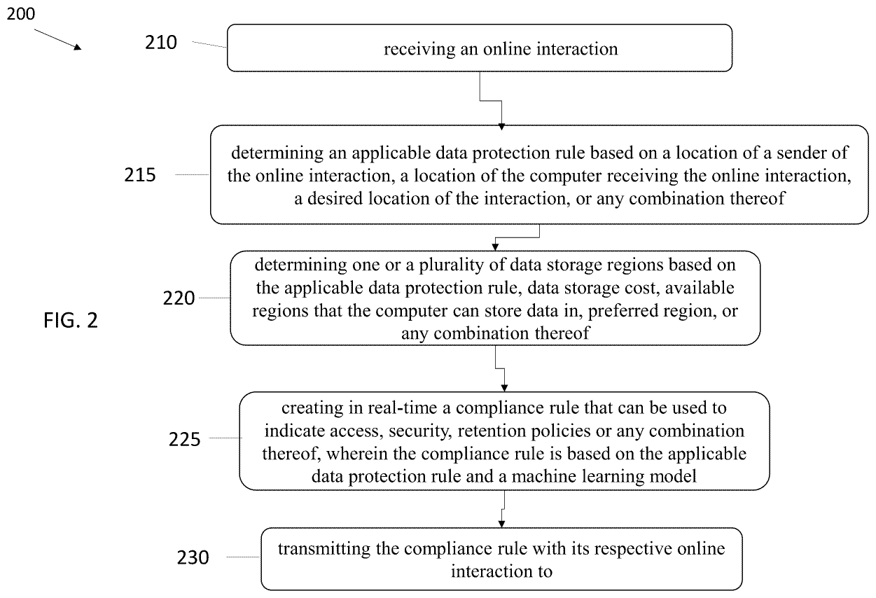

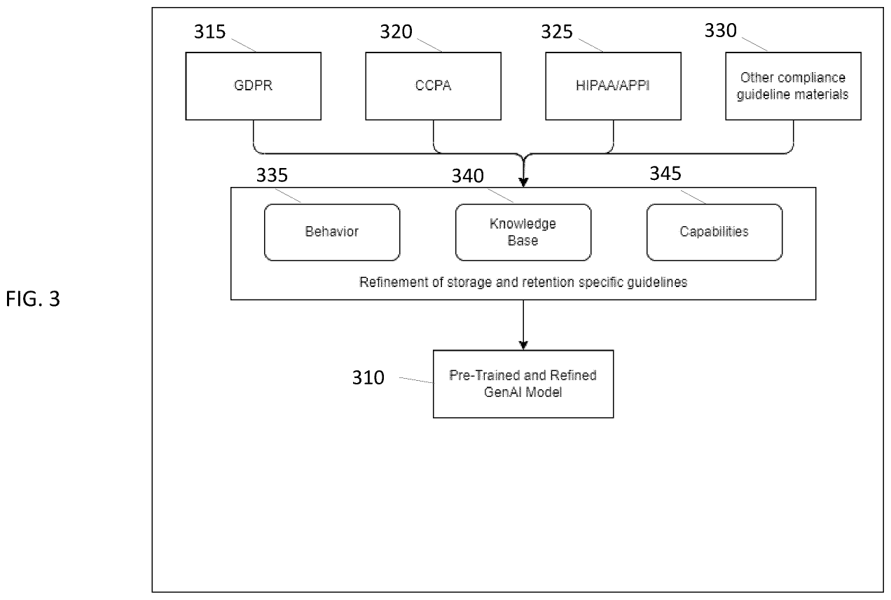

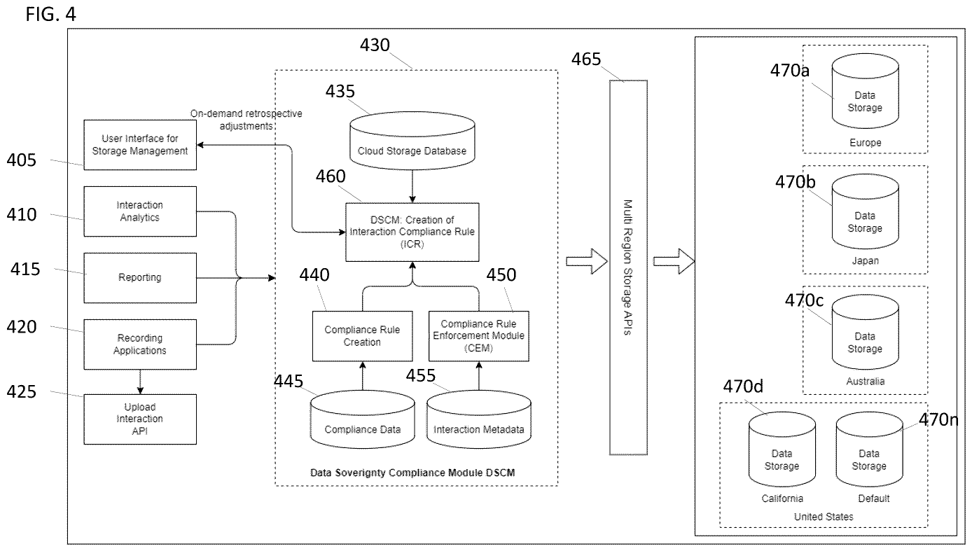

FIG. 1 shows a high-level block diagram of an exemplary computing device which may be used with embodiments of the present invention. Computing device 100 may include a controller or processor 105 that may be, for example, a central processing unit processor (CPU), a chip or any suitable computing or computational device, an operating system 115, a memory 120, a storage 130, input devices 135 and output devices 140 such as a computer display or monitor displaying for example a computer desktop system. Each of modules and equipment and other devices and modules discussed herein, e.g. as shown in FIG. 4 described below and modules and processes in FIG. 2 or 3 may be or include, or may be executed by, a computing device such as included in FIG. 1 although various units among these modules may be combined into one computing device.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may store for example, instructions (e.g. code 125) to carry out a method as disclosed herein, and/or data.

Executable code 125 may be any executable code, e.g., an application, a program, a process, task or script. Executable code 125 may be executed by controller 105 possibly under control of operating system 115. For example, executable code 125 may be one or more applications performing methods as disclosed herein, for example those of FIG. 2 or other figures, or other methods, according to embodiments of the present invention. In some embodiments, more than one computing device 100 or components of device 100 may be used for multiple functions described herein. For the various modules and functions described herein, one or more computing devices 100 or components of computing device 100 may be used. Devices that include components similar or different to those included in computing device 100 may be used, and may be connected to a network and used as a system. One or more processor(s) 105 may be configured to carry out embodiments of the present invention by, for example, executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data may be stored in a storage 130 and may be loaded from storage 130 into a memory 120 where it may be processed by controller 105. In some embodiments, some of the components shown in FIG. 1 may be omitted.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card (NIC), a modem, printer or facsimile machine, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

In general, the invention involves tagging each interaction (e.g., data associated with the interaction) that flows through a given computing system (e.g., multi-regional call center) with a dynamically generated compliance rule. The dynamically generated compliance rule can include information that allows compliance with data laws, including rules dictating storage, retention, security and/or transfer of the interaction data. Generating the compliance rule dynamically for each interaction can allow for any updates made to the laws to be integrated into how each interaction is handled in real-time and/or can allow for adjusting compliance for previously stored interactions. Generally, the invention can also involve selection a region when multiple regions can apply based on a strictness score which can account for level of compliance, cost and/or performance.

FIG. 2 is flowchart for a method automatic real-time identification of and compliance with worldwide data protection rules for online interactions, according to some embodiments of the invention. The method can involve receiving (e.g., by a computer 100, as shown in FIG. 1 above) an online interaction. (Step 210). The online interaction can be any type of online interaction, for example, voice calls, screen recordings, live chats, emails, social media messages, video recordings.

The method can also involve determining, by the computer, an applicable data protection rule based on a location of a sender of the online interaction, a location of the computer receiving the online interaction, a desired location of the interaction, or any combination thereof (Step 215).

The applicable data protection rule can be determined by using generative AI (e.g., a GPT). The GPT can be trained on a dataset that include global compliance regulations and/or case law scenarios. An Application Interface (API) can analyze interaction metadata, query a database (e.g., compliance knowledge database) that includes updated on global protection laws, and/or call the GPT. The API call can include interaction metadata.

Each interaction can have associated metadata. The metadata can include location of the computer transmitting the received interaction, the location of an organization of the computer transmitting the received interaction, the location of computer receiving the interaction, for a call, a number that was dialed by the interaction to send the interaction, region for interaction (e.g., data) processing activities, an indication as to whether the interaction was sent across borders, and/or a physical location of an agent handling the interaction. The list of applicable laws to be considered can be based on an API call to the trained GPT based on the metadata. The location data can be GPS data and/or IP address.

For example, an individual can transmit an interaction (e.g., text message) from a computer located in the USA to a contact center in the UK. The contact center in the UK can route the interaction to an agent in India. The contact center can store data in multiple locations depending on where the database availability is (e.g., UK, USA).

The API call to the GPT can include one or more of the interaction metadata and one or more prompts that can cause the GPT to return an applicable law. For example, assume an interaction having a list of applicable laws that include multiple laws, using the API with the interaction data and the metadata, with the appropriate prompts, can cause the GPT to return one applicable law from the list of applicable laws as the law to apply.

The GPT can be pre-trained. Turning to FIG. 3, FIG. 3 is a diagram showing the input to the GenAI model (e.g., the GPT), according to some embodiments of the invention. The GPT 310 can be trained with different sourced of compliance and/or regulation data. For example, GDPR (General Data Protection Regulation) 315 applies to the EU, CCPA (California Consumer Privacy Act) 320 to California, HIPAA (Health Insurance Portability and Accountability Act) and APPI 325 (Asia Pacific Privacy Initiative) and/or other guidelines 330 as are known in the art. In some embodiments, the GPT can undergo a refinement process. In some embodiments, the refinement process can includes refinement based on the following categories: i) behavior 335: can involve further data indicated how data is handled, processed, and/or protected under various scenarios according to the guidelines; ii) knowledge base 340: which can involve a comprehensive database of compliance knowledge that the AI can query or reference in its operations; and/or iii) capabilities 345: which can defines the operational abilities of the AI model, such as detecting non-compliance, suggesting compliance enhancements, and. or automated decision-making in compliance contexts.

The GPT can be designed to handle natural language processing tasks. Text extraction can be used to extract the metadata. For example, OpenAI's text-davinci-003 can be used to parse the transmitter's command and extract actionable tasks (e.g., the reason for the interaction).

Table 1, as shown below, is an example of inputs to train the GPT based on the metadata of a single example received interaction:

TABLE 1
Simplified Input to GPT

| Data Type | Data Value |
|---|---|
| OrganizationLocation | Germany |
| ContactCurrentLocation | Germany |
| CallOrigin | Spain |
| DataProcessingRegion | Germany |
| DataStorageLocation | Germany |
| DataSensitivity | High |
| DataType | Personal Data |
| DataSubjects | Customers |
| PurposeOfDataProcessing | Service Provision |
| CrossBorderDataTransfer″ | Yes |
| DataTransferMechanisms | Standard Contractual Clauses |
| AgentLocation | Germany |

The simplified inputs to GPT can be transformed into a binary context variable. In various embodiments, methods as are known in the art complete this transformation. For example, one-hot encoding can be used. Continuing with the example from Table 1, converting Table 1 into binary context variables can results in transformed inputs as shown below in Table 2.

TABLE 2
Transforming the Inputs Into Binary Context Variables

| | Binary Context | |
|---|---|---|
| # | Variable | Reason |
| 1 | OL-GE = 1 | Because OrganizationLocation = “Germany” |
| 2 | CCL_GE = 1 | Because ContactCurrentLocation = “Germany” |
| 3 | CO_ES = 1 | Because CallOrigin = “Spain” |
| 4 | DPR_GE = 1 | Because DataProcessingRegion = “Germany” |
| 5 | DSL_GE = 1 | Because DataStorageLocation = “Germany” |
| 6 | DS_HI = 1 | Because DataSensitivity = “High” |
| 7 | DT_PD = 1 | Because DataType = “Personal Data” |
| 8 | DSbj_C = 1 | Because DataSubjects = “Customers” |
| 9 | PODP_SP = 1 | Because PurposeOfDataProcessing = “Service |
| | | provision” |
| 10 | CBDT_Y = 1 | Because CrossBorderDataTransfer = “Yes” |
| 11 | DTM_SCC = 1 | Because DataTransferMechanisms = “Standard |
| | | Contractual Clauses” |
| 12 | AL_GE = 1 | Because AgentLocation = “Germany” |

The binary context variables can be used to create a context vector. The context vector can be created by assigning each binary variable to a unique dimension in the vector. Each dimension can be set to 1 or 0 based on whether the corresponding context feature is present or absent. By combining these binary values, the resulting multi-dimensional context vector effectively represents the overall state of all context variables. Continuing with the example of Table 1 and Table 2, Table 3 shows an example of a context vector with the binary context variables of Table 2.

TABLE 3
Context Vector Created Using Binary Context Variables

Context Vector = [OL_US, CCL_DE, CO_ES, DPR_US, DSL_US,
DS_HI, DT_PD, DSbj_C, PODP_SP, CBDT_Y, DTM_SCC, AL_IN] =
[1, 1, 1, 1, 1, 1, 1, 1, 1, 1, 1, 1]

The context vector can be used as input to a machine learning model. The machine learning model can be a Generative Adversarial Network (GenAI), e.g., Variational Autoencoder (VAE). The machine learning model can output a raw score that can reflect a degree to which each law may apply to the interaction. A probability for each potential applicability law can be determined based on the raw scores. The potential applicability law with the highest probability can be selected as the applicable law.

Continuing with the example of Table 3, inputting the example context vector of [1,1,1,1,1,1,1,1,1,1,1,1] into a GenAI trained on compliance data from GDPR, CCPA, FedRAMP, and HIPPA can result in a raw score vector output of [GDPR, CCPA, FedRAMP, HIPPA]=[2.1, 0.2, 0.5, 0.2], respectively. In this example, the probabilities determined for the raw score vector can be [GDPR, CCPA, FedRAMP, HIPPA]=[0.75, 0.08, 0.12, 0.08]. In this example, GDRP has the highest probability, thus selected as the applicable law.

The probabilities determined for the raw score vector can be based on historical compliance data, recent legal changes and/or jurisdiction specific nuances.

In some embodiments, to determine the probability for each potential applicable law, historical compliance data is collected and used to train a machine learning model (e.g., a variational encoder). The machine learning model can learn the relationships between interaction features and applicable laws. When a new interaction occurs, the context vector can be input into the trained model to generate the raw scores, which can indicate the relevance of each law. These raw scores can be normalized (e.g., using a Softmax function or min-max normalization) to convert them into probabilities that sum to one.

In some embodiments, if the probabilities are close (e.g., within 0.01 of each other) or specific operational mandates require adherence to the strictest possible regulations, then a strictness score can be determined. The strictness score can be determined for data storage determination, determination of data retention periods, security measure and access controls and/or data transfer and sharing policies.

The strictness score can be based on severity and/or comprehensiveness of each laws data protection stipulations. For example, scope of the data covered, penalties for non-compliance, and/or protective measures mandated by the law.

The strictness score can be based on one or more factors from each applicable regulation, such as: Penalties for Non-Compliance: Higher penalties suggest a stricter regulatory environment; Scope of Data Protection: Regulations that cover a broader range of data types or more sensitive information generally have higher scores; Compliance Requirements: More demanding or numerous compliance requirements (such as mandatory data audits, breach notification protocols, or consumer rights provisions) increase the score; and/or Provisions for Data Transfer: Stringent conditions on cross-border data transfers can reflect a higher strictness level.

The strictness score can be determined by assigning weights to different regulatory attributes in the compliance rule and aggregating them. For example, the strictness score can be determines as shown below in EQN. 1:

$$S = w 1 \times P + w 2 \times D + w 3 \times C + w 4 \times T \qquad EQN . 1$$

where, S is the strictness score, P is the penalty score, scaled based on the severity and likelihood of penalties under the regulation; D is the data protection scope score, reflecting the extent and types of data covered.; C represents the compliance requirements score, based on the complexity and number of obligations, T accounts for the transfer restrictions score, considering the strictness of cross-border data transfer conditions; and w1, w2, w3, w4 are the weights assigned to each of these factors, reflecting their relative importance in determining strictness. The weights can indicate the relative importance of each of the factors. The weight be based on user input.

The penalty score can represent severity and likelihood of penalties or fines under the regulation. The maximum penalties defined by the given regulation can be analyzed. For example, GDPR may have higher penalties then other regulations such that it can have high value whereas CCPA has relatively low fine hence can have low value.

The data protection scope score can represent a depth of data protection covered by given regulation. For example, whether the data protection is globally applicable, e.g., GDPR or locally applicable rule, whether the data protection is applicable to a specific type of organization, e.g., health related data or for all organizations.

The compliance requirement score can represent the complexity, number, and/or nature of compliance obligations under the regulation and can be calculated based on number of regulations that each law offers (e.g., more regulations or obligations can result in a higher score.)

The transfer restrictions score can represent a strictness of rules governing cross-border data transfers under the regulation by, for example, checking if the regulation imposes specific conditions for transferring data outside its jurisdiction.

For example, assume two laws GDPR and CCPA. If the GDPR is generally recognized as stricter due to its broader scope of protection, higher penalties, and more stringent transfer rules, it can receive a higher strictness score. For example, assume the inputs as shown below in Table 1:

TABLE 1
Penalties (P): GDPR = 8, CCPA = 5
Data Protection (D): GDPR = 9, CCPA = 7
Compliance Requirements (C): GDPR = 8, CCPA = 6
Transfer Restrictions (T): GDPR = 9, CCPA = 6
Weights are set as: w1 = 0.4, w2 = 0.3, w3 = 0.2, w4 = 0.1

Using EQN. 1, the strictness scores are as shown in Table 2

TABLE 2
GDPR Score = 0.4 × 8 + 0.3 × 9 + 0.2 × 8 + 0.1 × 9 = 8.40.4\times 8 +
0.3\times 9 + 0.2\times 8 + 0.1\times 9 = 8.40.4 × 8 + 0.3 × 9 + 0.2 ×
8 + 0.1 × 9 = 8.4
CCPA Score = 0.4 × 5 + 0.3 × 7 + 0.2 × 6 + 0.1 × 6 = 5.90.4\times 5 +
0.3\times 7 + 0.2\times 6 + 0.1\times 6 = 5.90.4 × 5 + 0.3 × 7 +0.2 ×
6 + 0.1 × 6 = 5.9

The determined region can be modified based on the strictness score. For example, assume in the CCPA and HIPPA are the highest probabilities and are within 0.01 of each other, for example, 0.45 and 0.46, respectively, then the law with the highest strictness score can be used, in this example, HIPPA.

In some embodiments, the system can provide reasoning for selecting the particular law providing the probabilities and/or strictness score as output.

Turning back to FIG. 2, the method can also involve determining one or a plurality of data storage regions based on the applicable data protection rule, data storage cost, available regions that the computer can store data in, preferred region, or any combination thereof (Step 220).

Determining the one or a plurality of data storage region can be based on the applicable data protection rule. If the applicable data protection rule only has one region that is associated with it, then that one region is selected as the data storage region. If the applicable data protection rule has more a plurality of regions that is associated with it, then a determination can be made as to which region to choose. The determination of which region to select can be based on a best region determination. The best region determination can be based on availability of data storage in the plurality of regions, data storage costs and/or a preferred region of the transmitter of the interaction.

In some embodiments, the best region determination can involve determining a compliance score. For example, assuming the applicable data protection rule is GDPR. Assume that four regions supported for GDRP are London, Frankfurt, Paris and Stockholm. The four regions can be input to the machine learning model (e.g., the GenAI) that can return a compliance score (CS) that can indicate a level of compliance for the respective region with the applicable data protection rule. The compliance score can be on a 0 to 10 scale, 0 to 100 scale, or any scale as is trained into the GenAI.

In this example, the compliance score for each region can be between 0 and 10 with 10 being the highest compliance. The compliance score can be as follows: London=8, Frankfurt=7, Paris=6 and Stockholm=7. The cost and/or speed for each region can be accounted for. The cost can be the expenses associated with storing data in a particular region.

The cost of storing interactions can be determined by a pricing model, e.g., as provided by a respective cloud vendor or the product itself. The cost can vary based on a storage class used, such as Standard, Infrequent Access, or Archive.

The speed of accessing interactions can depends on the storage type, such as SSD-based storage, which can provide faster read/write operations. The speed can also be based on data access latency, network bandwidth, and/or other related parameters as is known in the art.

The speed can be the network and/or data transfer speeds achievable in a region, which can impact how quickly data can be accessed and processed. Continuing with the example, assume cost (in USD) are cost in Frankfurt, C_{Frankfurt}=100, cost in London, C_{London}=150, cost in Paris, C_{Paris}=120, and cost in Stockholm, C_{Stockholm}=110. Assume speed is speed (in Mbps) in Frankfurt, S_{Frankfurt}=100, speed in London, S_{London}=150, speed in Paris, S_{Paris}=120, and speed in Stockholm, S_{Stockholm}=110.

The compliance scores (CS), costs (C), and speed (S) can be normalized by dividing each value by a maximum value in each category (e.g., when a higher value is better, e.g., compliance), or dividing the maximum value by the actual value (e.g., when a lower value is better), as shown below in EQNs. 1 and 2:

$${X}^{′} = [ x 1 / max ( X ) , x 2 / max ( X ) , … , xn / max ( X ) ] \qquad EQN . 1$$

$${X}^{′} = [ max ( X ) / x 1 , max ( X ) / x 2 , … , max ( X ) / xn ] \qquad EQN . 2$$

where X is the compliance score (CS), cost (C), or speed (S) vectors, X′ is the respective normalized compliance score (CS), cost (C), or speed (S) vectors, xn is the vector value, where n is 1 to number of values, and max (X) is the maximum value among the vector values xn.

In some embodiments, the compliance score (CS), cost (C), or speed (S) can be weighted to give more or less importance to these factors. The weights can be assigned based on a user preference of order of importance of the factors. For example, if a user desires speed over costs, then speed can be weighted more than costs.

The determination of which region to pick can be determined by taking the maximum of EQN. 3 as shown below for each location:

$$RSuitable = max ( WC \times {C}_{Region} - WCR \times {C}_{Region} - WS \times {S}_{Region} ) \qquad EQN . 2$$

Where WC is the weight of the cost, C_{Region}=cost vector, WCR is the weight of the cost in the region, WS is the cost of the speed and S_{region} is the speed of in the region.

For example, assume a compliance score vector, cost vector and speed vector as shown: Compliance Scores CR=[CR_{Frankfurt}, CR_{London}, CR_{Paris}, CR_{Stockholm}]=[7, 8, 6, 7], Costs C=[C_{Frankfurt}, C_{London}, C_{Paris}, C_{Stockholm}]=[100, 150, 120, 110], and Speeds S=[S_{Frankfurt}, S_{London}, S_{Paris}, S_{Stockholm}]=[50, 40, 45, 48].

In the current example, applying EQN. 2 results in:

$${R}_{Suitable} = max \begin{matrix}( WC \cdot \frac{150}{{C}_{Frankfurt}} + WCR \cdot \frac{{CR}_{Frankfurt}}{8} + WS \cdot \frac{{S}_{Frankfurt}}{50} ) \\ ( WC \cdot \frac{150}{{C}_{London}} + WCR \cdot \frac{{CR}_{London}}{8} + WS \cdot \frac{{S}_{London}}{50} ) \\ ( WC \cdot \frac{150}{{C}_{Paris}} + WCR \cdot \frac{{CR}_{Paris}}{8} + WS \cdot \frac{{S}_{Paris}}{50} ) \\ ( WC \cdot \frac{150}{{C}_{Stockholm}} + WCR \cdot \frac{{CR}_{Stockholm}}{8} + WS \cdot \frac{{S}_{Stockholm}}{50} )\end{matrix}$$

Resulting in:

$$Frankfurt = 0.6 * 150 / 100 + 0.3 * 7 / 8 + 0.1 * 50 / 50 = 1.2625$$

$$London = 0.6 * 150 / 150 + 0.3 * 8 / 8 + 0.1 * 40 / 50 = 0.98$$

$$Paris = 0.6 * 150 / 120 + 0.3 * 6 / 8 + 0.1 * 45 / 50 = 1.065$$

$$Stockholm = 0.6 * 150 / 110 + 0.3 * 7 / 8 + 0.1 * 48 / 50 = 1.17$$

Taking the maximum of these values results in Frankfurt as being the selected region.

Turning back to FIG. 2, the method can also involve creating in real-time, by the computer, a compliance rule that can be used to indicate access, security, retention policies or any combination thereof, wherein the compliance rule is based on the applicable data protection rule and a machine learning model (Step 225).

The compliance rule can specify a compliance policy for each online interaction such that each online interaction is stored, retained, and transmitted in accordance with the compliance rule. The compliance rule can specify a data storage region that is a region where the data (e.g., interaction data) is to be stored (e.g., the determine region); a data retention policy which specifies how long the data is to be retained based on its sensitivity (e.g., PCI, PII and/or health data) and/or relevant regulations; a data transfer policy that governs the rules for transferring data across regions and/or ensuring is complies with legal restrictions on cross-border data movement; and/or a data security policy that ensures the appropriate encryption and/or access controls are in place to protect sensitive customer data and/or maintain compliance with regional security standards.

The compliance rule can be based on a selected region as is determined in step 220. The applicable rule and/or the selected region for the applicable rule can be input to a machine learning model (e.g., GenAI). The input to the machine learning model can be a context vector. For example, the input can be a context vector of {“Region”: “Frankfurt”, “Rule”: “GDR-P” }.

The machine learning processing can involve encoding the input. Encoding the input can be converting JSON (or string or XML) to a tokenizable string format for the machine learning model, for example, “[START]Region: Frankfurt, Rule: GDPR [END]”. The input in a string format can be tokenized. Continuing with the example, string tokenization can be [“[START]”, “Region”, “:”, “Frankfurt”, “,”, “Rule”, “:”, “GDPR”, “[END]” ]. The tokenized string can be input to the GenAI and output the compliance rule. Continuing with the example, the compliance rule for the string tokenization can be as follows:

```
{
  “Region″: “Frankfurt”,
  “Rule″: “GDPR”,
  “Jurisdiction”: “European Union”,
  “DataRetention”: “24 months”,
  “Security”: “AES-256 encryption”,
  “DataTransfer”: {
```

“DataTransferOutOfRegionAllowed”: “Yes”,
“AllowedEntities”: “List of entities allowed/RBAC”,
“DownloadAllowed”: “Yes”
},

“Consent”: “Explicit, informed, and freely given”
}

The compliance rule indicates a region, rule, jurisdiction, data retention policy, security encryption specification, data transfer specification, and consent requirement.

As is apparent to one of ordinary skill in the art, the compliance rule can be specific to the input. For example, some applicable rules in a particular region can have additional requirement or lesser requirement then what is shown in the example (e.g., PIPEDA (Personal Information Protection and Electronic Documents Act)—Canada, does not restrict cross-border data transfers or The CCPA does not explicitly restrict or impose specific conditions on the transfer of personal data outside of California or the United States. Similarly, Under HIPAA, Consent is not required for processing protected health information (PHI) for certain purposes, such as treatment, payment, or healthcare operations).

In this manner, a compliance rule can be determined in real time for interactions, dynamically identifying applicable data protection laws and determining a rule that is specific to each interaction.

The method can also involve transmitting, by the computer, the compliance rule with its respective online interaction to a multi-region cloud storage system (Step 230). The multi-region cloud storage system can be accessed by Entities and applications that are granted access can be chosen from a predefined list, including analytics tools, interaction recording and playback systems, authorized administrators and users requiring the data, other products or internal modules within the CCaaS software, external agencies, or third-party authorized applications using the data for analysis or similar purposes, litigation and legal systems,

Each online interaction can be tagged with its respective compliance rule. A particular allocation of storage can be made based on the compliance rule in data centers located within the legally compliant regions as specified in the compliance rule. In some embodiments, georedundant storage can be employed within compliant regions.

In some embodiments, automatic review of stored data and purging of data post retention period is performed. The security protocols can be periodically updated in order to ensure that the compliance rule is using recent versions of the protocols specified. In some embodiments, the system can use role based access controls to comply with the compliance rule.

In some embodiments, an interactive API is provided to interact with various cloud storage providers to ensure data is stored in the correct geographical location.

FIG. 4 is an example of a system architecture automatic real-time identification of and compliance with worldwide data protection rules for online interactions, according to some embodiments of the invention. The system architecture can include a user interface for storage management 405, interaction analytics application 410, reporting 415, recording applications 420, upload interaction application interface (API) 425, data sovereignty compliance module (DSCM) 430, one or more APIs 435, and a plurality of data storages 435a, 435b, . . . 435n.

The user interface for storage management 405 can communicate with the DCSM 430. The user interface for storage management 405 can allows users to interact directly with the DCSM 430 including viewing and modifying where data is stored and how it is handled. In some embodiments, the user interface for storage management 405 includes options for manual adjustments and viewing the status of data across different storage locations.

The interaction analytics application 410 can communicate with the DCSM 430. The interaction analytics application 410 can be a linguistic analytics application. The interaction analytics application 410 can converts interactions into as is known in the art. Interaction analytics application 410 can allows users to view, filter, group, and/or search for different keywords and/or metrics in the interaction data. The interaction analytics application 410 can provide insights that can impact compliance decisions, such as determining the nature of the data, its origin, and other attributes relevant to compliance as are known in the art.

The reporting module 415 can communicate with the DCSM 430 and allow users to view information about performance, diagnostics of a system that generates the interactions (e.g., contact center). The reporting module 415 can generates reports that based on locations of the data storage and compliance status, which can be useful for audit trails and compliance checks. For example, reports that show how much data is stored in each region. Reports can also be generate information on a one-time basis or on a regular, recurring schedule.

The recording applications 420 can communicate with the DCSM 430. The recording applications 420 can captures interactions across various channels that may need to comply with regional data protection laws. The recording application 420 can trigger an event or alert to indicate the completion and generation of a new interaction.

The upload interaction application interface (API) 425 can communicate with the DCSM 430. The upload interaction application interface (API) 425 provides a programmable interface for uploading recorded interactions to the DCSM. The upload interaction application interface (API) 425 can complete metadata tagging. In some embodiments, when a new interaction is generated and finalized, the recording applications 420 can activate the upload interaction application interface (API) 425 to upload the interaction to storage (e.g., cloud storage 435). The API request can include detailed metadata, as described above, within its body. The metadata can assist in the decision-making process for the DCSM 430. The result of calling this API can be the successful upload of the interaction to cloud storage. Table 3 is an example of the API and the required body.

```
TABLE 3
Method: POST
Endpoint: api/v2.0/<tenantld>/files
Body: The actual interaction file and metadata
{
  “Id”: “XYZ1234-ABCD5678”,
  “BusinessNo”: 456,
  “InteractionId”: “789”,
  “Metadata”: {
    “Application”: “RecordingApp”,
    “businessUnit”: “789”,
    “codec”: “MP3”,
    “ContactId”: “789”,
    “endTime”: “2024-10-07T01:43:29.245Z”,
    “FileName”: “2024-10-07-01-43-04_789_VOICE-789.mp4”,
    “mediaType”: “VOICE”,
    “participants”: [
      {
        “Ani”: “+123456”,
        “ParticipantType”: “CUSTOMER”,
        “Location”: “ContactLocation1”
      },
      {
        “UserId”: “456789”,
        “ParticipantType”: “AGENT”,
        “Location”: “AgentLocation1”
      }
    ],
    “recordingId”: “789”,
    “SegmentId”: “789”,
    “startTime”: “2024-10-07T01:43:04.327Z”,
    “tenantId”: “789”,
    “type”: “segment”,
    “agentLocation”: “AgentLocation1”,
    “organizationLocation”: “OrgLocation1”,
    “contactCurrentLocation”: “ContactLocation1”,
    “dataProcessingActivitiesRegion”: “Region1”
  }
}
```

The DCSM 430 can include cloud storage database, DSCM interaction compliance rule creation module 440, a compliance database 445, a compliance rule enforcement module 450, an interaction metadata database 455, and a Data Sovereignty Compliance Module (DSCM) module 460. The DSCM module 460 can manage and/or control interaction between modules.

The DSCM ICR module 460 can communicate with the user interface 405, the could storage database 435, the compliance rule create module 440 and/or the compliance rule enforcement module 450. The DSCM ICR module 460 can serve as a centralized repository within the system architecture. The DSCM ICR module 460 can securely store and/or manage details (e.g., time, sender, receiver, and/or location) of each interaction and/or additional location details (e.g., interaction context, interaction analytics metadata, or any combination thereof) that can be used for ensuring compliance with various data protection regulations. The DSCM ICR module 460 can also interface with pre-trained GenAI model to analyse and/or interpret metadata associated with each interaction.

The API 465 can be used by the DSCM ICR module 460 to retrieve data from the database that contains updates on global data protection laws.

The compliance rule creation module 440 can communicate with the compliance data database 445 and the DSCM ICR 460. The compliance rule creation module 440 can create and/or identify compliance rules. The compliance rules can be govern the access, security and/or retention policies of the interaction which can be compliant with the given data protection law.

The Compliance rule enforcement module 450 can communicate with the interaction metadata database 455 and the DSCM ICR 460. The compliance rule enforcement module 450 can ensure that every interaction complies with the respective data protection laws by enforcing the interaction compliance rules, ensuring that every data interaction adheres to the legal and/or organizational standards as specified in the ICR for the respective interaction.

The one or more APIs 465 can be API's that allow communication with a plurality of data storages 470a, 470b, 470c, 470d, . . . 470n, such that the DSCM 430 can transmit the interaction data to the data storage in a region as specified in the compliance rule (as described above).

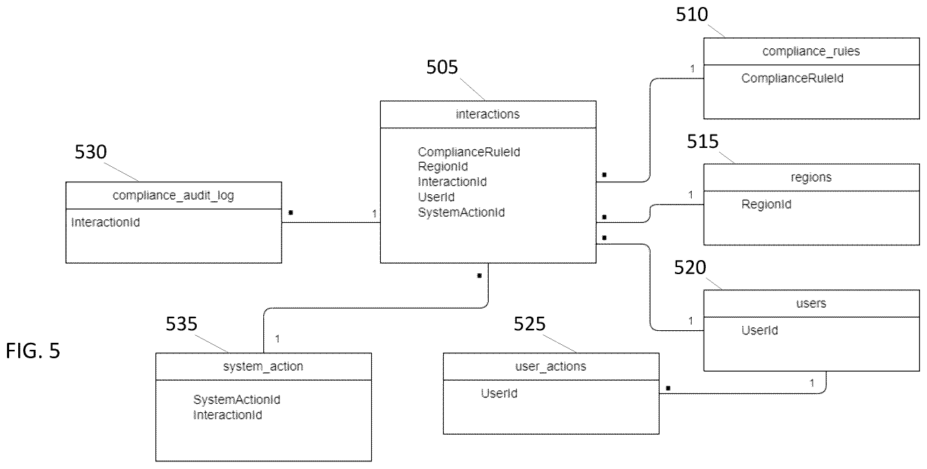

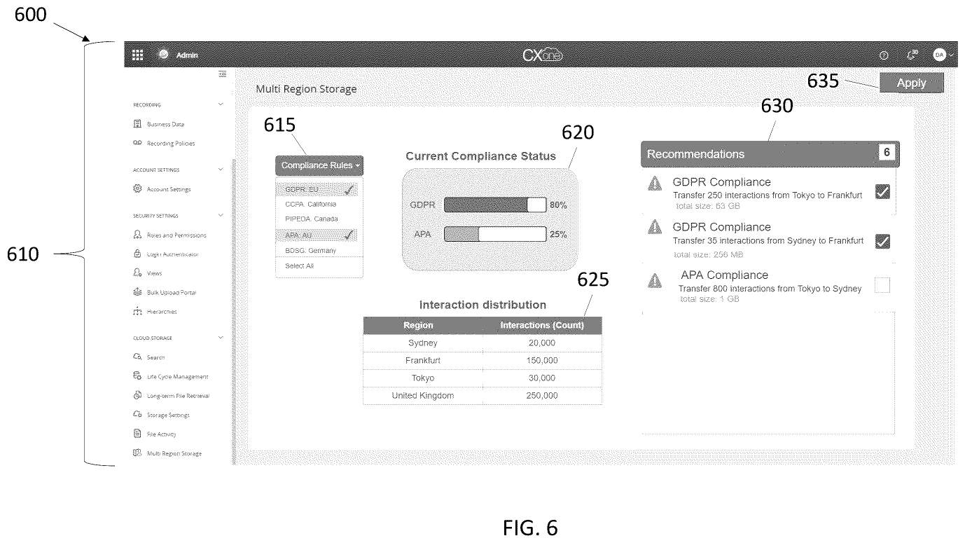

FIG. 5 is a database schema 500 for a DSCM (e.g., DSCM 320 as described above in FIG. 4), according to some embodiments.

The database schema 500 can be implemented on one database or multiple databases. The database schema can include interaction data schema 505, a compliance rules (e.g., interaction compliance rules) data schema 510, a regions data schema 515, a user data schema 520, a user actions data schema 525, and a compliance audit log data schema 530.

The interaction data schema 505 can be as shown below in Table 4:

TABLE 4

| Field Name | Purpose | Data Type |
|---|---|---|
| InteractionID | Unique identifier for each interaction | Integer |
| | | (Primary Key) |
| Timestamp | Date and time the interaction was | DateTime |
| | recorded | |
| UserID | Identifier for the user involved | Integer |
| RegionID | Links to the Regions Table | Integer |
| | | (Foreign Key) |
| Content | Actual content of the interaction | Text |
| ComplianceRuleID | Links to the Compliance Rules Table | Integer |
| | | (Foreign Key) |
| SystemActionID | Unique identifier for each system | Integer |
| | action | (Foreign Key) |

TABLE 5

| Field Name | Purpose | Data Type |
|---|---|---|
| ComplianceRuleID | Unique identifier for each rule | Integer |
| | | (Primary Key) |
| Description | Text description of the rule | Text |
| DataRetentionPeriod | Specifies data retention duration | Integer |
| SecurityRequirements | Specifies required security | Text |
| | measures | |
| DataTransferRules | Rules about data transfer | Text |
| | permissions | |
| IsActive | Indicates if the rule is active | Boolean |

TABLE 6

| Field Name | Purpose | Data Type |
|---|---|---|
| RegionID | Unique identifier for each region | Integer |
| | | (Primary Key) |
| RegionName | Name of the region | Text |
| ComplianceStandards | Compliance standards of the region | Text |
| DataCenterLocation | Physical or cloud location of data | Text |
| | center | |

TABLE 7

| Field Name | Purpose | Data Type |
|---|---|---|
| LogID | Unique identifier for each log entry | Integer (Primary Key) |
| InteractionID | Links to the Interactions Table | Integer (Foreign Key) |
| Timestamp | Date and time of the audit | DateTime |
| AuditOutcome | Outcome of the compliance check | Text |
| Notes | Additional notes or actions taken | Text |

TABLE 8

| Field Name | Purpose | Data Type |
|---|---|---|
| ActionID | Unique identifier for each action | Integer (Primary Key) |
| UserID | Links to a user table | Integer (Foreign Key) |
| ActionType | Type of action performed | Text |
| Timestamp | When the action was performed | DateTime |

TABLE 9

| Field Name | Purpose | Data Type |
|---|---|---|
| RegionID | Links to the Regions Table | Integer (Foreign Key) |
| UserID | Unique identifier for each user | Integer (Primary Key) |
| Role | Role of the user (e.g., Admin, Agent) | Text |
| Permissions | Specific permissions or access rights | Text |
| | for the user | |

TABLE 10

| Field Name | Purpose | Data Type |
|---|---|---|
| SystemActionID | Unique identifier for each system action | Integer |
| | | (Primary Key) |
| ActionType | Type of system action | Text |
| Timestamp | When the action was performed | DateTime |
| Details | Detailed description or results of the | Text |
| | action | |
| InteractionID | Links to the Interactions Table | Integer |
| | | (Foreign Key) |

In some embodiments, on-demand retrospective analysis is provided. Users and/or system can interact with the system (via GPT interfaces) to assess the current data storage practices and/or bring previously stored interactions into compliance with updated regulations. This can ensure that the system is able to comply with evolving laws, and/or provides flexibility to address compliance issues as they arise. For example, if a new regulation is introduced or if an organization needs to adjust its storage practices to meet changing legal requirements, users can ask the system to perform actions, e.g., making stored interactions compliant with the latest rules.

The on-demand retrospective analysis can involve post-processing of results, response generation.

During operation, a user can trigger a request for compliance checks and/or rectifications for historical interactions. The user can provide a specific natural language command via an interface (e.g., “Check the compliance status of all call recordings and make them compliant”). The command can specify what needs to be checked and corrected for compliance.

The command can be parsed and interpreted to extract actionable tasks, such as identifying non-compliant interactions and applying corrections. The interaction databases can be queried to retrieve records and/or metadata for stored interactions. The retrieved data can include compliance statuses and other relevant details for historical interactions. The interactions can be checked to determine whether they adhere to a respective applicable data protection laws. For non-compliant interactions, corrective actions (e.g., updating metadata, applying retention policies, and/or enforcing encryption) can be executed automatically.

After the request is executed, a detailed response can be created to summarize the compliance checks and/or corrective actions taken. The results of the executed command can be evaluated, identifying the extent of non-compliance and summarizing the actions taken to correct the issues.

A final response can be formulated based on the analysis. The final response can be delivered to the user through the same interface or a preferred communication channel, detailing the non-compliance resolution process.

The user communication can involve delivery. The final refined response is delivered to the user through the initial interface or a preferred communication channel. Feedback Loop: Optionally, the system may include a mechanism for the user to provide feedback on the adequacy of the response and the effectiveness of the corrective actions taken.

FIG. 6 is a graphical user interface (GUI) 600, according to some embodiments of the invention.

The GUI 600 can include a navigation and selection section 610. Users can interact with the compliance rules section 615 to filter and/or view specific data, adjust settings, or check detailed compliance levels for different regulations. As can be seen in this example, the compliance rules section 615 is showing that GDPR EU and APA AU are selected. The GUI 600 can include a current compliance status section 620, which shows for the selected GDPR EU and APA AU a level of compliance, for example, GDPR EU shows 80% compliance and APA AU shows 25% compliance.

The interaction distribution section 625 shows a distribution of received interactions by region. For example, it lists regions such as Sydney, Frankfurt, Tokyo, and the United Kingdom along with the number of interactions (count) in each region. This can assist users to understand where data interactions are most frequent, which can be important for planning data storage and transfer strategies in compliance with local laws.

The recommendations section 630 can provide actionable recommendations for improving compliance. Each recommendation can include a specific action, such as transferring a certain number of interactions from one city to another (e.g., from Tokyo to Frankfurt) to enhance GDPR compliance. The recommendations section 630 can also provides details like the total size of the data to be transferred. The apply button 635 can allow the recommendations to be entered.

The aforementioned flowcharts and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved, It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

As will be appreciated by one skilled in the art, aspects of the present invention may be embodied as a system or an apparatus. Accordingly, aspects of the present invention may take the form of an entirely hardware embodiment or an embodiment combining software and hardware aspects that may all generally be referred to herein as a “circuit,” “module” or “system.”

The aforementioned figures illustrate the architecture, functionality, and operation of possible implementations of systems and apparatus according to various embodiments of the present invention. Where referred to in the above description, an embodiment is an example or implementation of the invention. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions. It will further be recognized that the aspects of the invention described hereinabove may be combined or otherwise coexist in embodiments of the invention.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with materials equivalent or similar to those described herein.

While the invention has been described with respect to a limited number of embodiments, these should not be construed as limitations on the scope of the invention, but rather as exemplifications of some of the preferred embodiments. Other or equivalent variations, modifications, and applications are also within the scope of the invention. Accordingly, the scope of the invention should not be limited by what has thus far been described, but by the appended claims and their legal equivalents.

1. A method for automatic real-time identification of and compliance with worldwide data protection rules for online interactions, the method comprising:
receiving, by a computer, an online interaction;
determining, by the computer, an applicable data protection rule based on a location of a sender of the online interaction, a location of the computer receiving the online interaction, a desired location of the interaction, or any combination thereof;
determining, by the computer, one or a plurality of data storage regions based on the applicable data protection rule, data storage cost, available regions that the computer can store data in, preferred region, or any combination thereof;
creating in real-time, by the computer, a compliance rule that can be used to indicate access, security, retention policies or any combination thereof, wherein the compliance rule is based on the applicable data protection rule and a machine learning model; and
transmitting, by the computer, the compliance rule with its respective online interaction to a multi region cloud storage system.

2. The method of claim 1 wherein determining the applicable data protection rule is further based on a machine learning model, wherein the machine learning model is trained a plurality of interactions, each interaction including the sender of the online interaction, the location of the computer receiving the online interaction, a desired location of the interaction, or any combination thereof.

3. The method of claim 1 wherein for plurality of data storage region determining the data storage region further comprises:
determining, by the computer, a compliance score for each of the plurality of regions based on a machine learning model;
determining, by the computer, a cost for each of the plurality of regions;
determining, by the computer, a speed for each of the plurality of regions; and
selecting one region of the plurality of regions to store the data in based on the compliance score, the cost, the speed or any combination thereof.

4. The method of claim 3 wherein the selection of one region is based on weighting the compliance score, the cost and the speed.

5. The method of claim 1 further comprising receiving a request to delete, change, store or access data from an application, and determining based on the compliance rule whether the request can be executed.

6. The method of claim 1 further comprising:
receiving a request to determine compliance rate for a particular entity;
determining the compliance rate by evaluating the transaction location storage and associated metadata; and
transmitting, by the computer, the compliance rate to a display.

7. The method of claim 1 wherein creating in a compliance rule further comprises determining a strictness score that resolves conflict between multiple compliance rules that are determined for a single interaction.

8. A system for automatic real-time identification of and compliance with worldwide data protection rules for online interactions, the system comprising:
a processor configured to:
receive an online interaction;
determine an applicable data protection rule based on a location of a sender of the online interaction, a location of the computer receiving the online interaction, a desired location of the interaction, or any combination thereof;
determine one or a plurality of data storage regions based on the applicable data protection rule, data storage cost, available regions that the computer can store data in, preferred region, or any combination thereof;
create in real-time, a compliance rule that can be used to indicate access, security, retention policies or any combination thereof, wherein the compliance rule is based on the applicable data protection rule and a machine learning model; and
transmit the compliance rule with its respective online interaction to a multi region cloud storage system.

9. The system of claim 8 wherein determining the applicable data protection rule is further based on a machine learning model, wherein the machine learning model is trained a plurality of interactions, each interaction including the sender of the online interaction, the location of the computer receiving the online interaction, a desired location of the interaction, or any combination thereof.

10. The system of claim 8 wherein for plurality of data storage region determining the data storage region further comprises:
determine a compliance score for each of the plurality of regions based on a machine learning model;
determine a cost for each of the plurality of regions;
determine a speed for each of the plurality of regions; and
select one region of the plurality of regions to store the data in based on the compliance score, the cost, the speed or any combination thereof.

11. The system of claim 10 wherein the selection of one region is based on weighting the compliance score, the cost and the speed.

12. The system of claim 8 wherein the processor is further configured to receive a request to delete, change, store or access data from an application, and determining based on the compliance rule whether the request can be executed.

13. The system of claim 8 wherein the processor is further configured to:
receive a request to determine compliance rate for a particular entity;
determine the compliance rate by evaluating the transaction location storage and associated metadata; and
transmit the compliance rate to a display.

14. The system of claim 8 wherein creating in a compliance rule further comprises determining a strictness score that resolves conflict between multiple compliance rules that are determined for a single interaction.

15. A non-transitory computer program product comprising instructions which, when the program is executed cause the computer to:
receive an online interaction;
determine an applicable data protection rule based on a location of a sender of the online interaction, a location of the computer receiving the online interaction, a desired location of the interaction, or any combination thereof;
determine one or a plurality of data storage regions based on the applicable data protection rule, data storage cost, available regions that the computer can store data in, preferred region, or any combination thereof;
create in real-time, a compliance rule that can be used to indicate access, security, retention policies or any combination thereof, wherein the compliance rule is based on the applicable data protection rule and a machine learning model; and
transmit the compliance rule with its respective online interaction to a multi region cloud storage system.

16. The non-transitory computer program product of claim 14 wherein determining the applicable data protection rule is further based on a machine learning model, wherein the machine learning model is trained a plurality of interactions, each interaction including the sender of the online interaction, the location of the computer receiving the online interaction, a desired location of the interaction, or any combination thereof.

17. The non-transitory computer program product of claim 14 wherein for plurality of data storage region determining the data storage region further comprises:
determine a compliance score for each of the plurality of regions based on a machine learning model;
determine a cost for each of the plurality of regions;
determine a speed for each of the plurality of regions; and
select one region of the plurality of regions to store the data in based on the compliance score, the cost, the speed or any combination thereof.

18. The non-transitory computer program product of claim 17 wherein the selection of one region is based on weighting the compliance score, the cost and the speed.

19. The non-transitory computer program product of claim 14 wherein the computer program instructions further cause the computer to receive a request to delete, change, store or access data from an application, and determining based on the compliance rule whether the request can be executed.

20. The non-transitory computer program product of claim 14 wherein the computer program instructions further cause the computer to:
receive a request to determine compliance rate for a particular entity;
determine the compliance rate by evaluating the transaction location storage and associated metadata; and
transmit the compliance rate to a display.
